(19) United States
(12) Patent Application Publication
(10) Pub. No.: US 2026/0249465 A1
(43) Pub. Date: Aug. 27, 2026

(54) MONITORING DEVICE AND ROBOT MONITORING SYSTEM

(71) Applicant: FANUC CORPORATION, Yamanashi (JP)

(72) Inventor: Shuxiao XIE, Yamanashi (JP)

(21) Appl. No.: 18/871,155

(22) PCT Filed: Jun. 24, 2022
(86) PCT No.: PCT/JP2022/025357

§ 371 Date: Dec. 3, 2024

(51) Int. Cl. B25J 9/16

(52) U.S. Cl. CPC B25J 9/1674

(57) ABSTRACT

A monitoring device according to the present embodiment includes: a first receiving unit for receiving, in accordance with a production program for causing a robot to execute a predetermined production operation, an execution history record including a start date and time and an end date and time of the production operation from a robot control device configured to control the robot; a second receiving unit for receiving a change history record including a date and time when the production program or a variable was manually changed; and a determination unit for determining whether a time at which the production program or the variable was manually changed is during the production operation by comparing the change history record with the execution history record.

### RELATED APPLICATIONS

The present application is a National Phase of International Application No. PCT/JP2022/025357 filed Jun. 24, 2022.

### TECHNICAL FIELD

Embodiments of the present invention relate to a monitoring device and a robot monitoring system having a function of monitoring a change in information related to a production operation of a robot.

### BACKGROUND ART

Many robots are used in production lines of factories. Monitoring the operational states of these robots has become an important technique in terms of maintaining manufacturing efficiency, quality, and the like. For example, a technique for monitoring the operation states of a large number of robots at remote locations is known (for example, Patent Literature 1). However, the conventional technique monitors the occurrence of an abnormality, such as a failure of a robot, using a preset monitoring algorithm and notifies the person responsible for managing the robot, the person responsible for managing the system, and the like of the abnormality.

### CITATION LIST

### Patent Literature

Patent Literature 1: Japanese Unexamined Patent Application Publication No. 2015-131381

### SUMMARY

### Problem to be Solved

However, the monitoring algorithm does not take into account change operations by the operator. Therefore, the monitoring program cannot detect changes in the program of the robot, changes in variables such as the operation speed, and changes in system variables by the operator, and the person responsible for managing the robot and the person responsible for managing the system cannot know these changes by the operator. However, changes made by the operator can cause abnormalities during the production operation of the robot regardless of whether the changes are done correctly or not. Therefore, the person responsible for managing the robot and the person responsible for managing the system should recognize the changes by the operator as a risk for abnormalities to occur. Given this background, it is desired to propose a technique that can monitor changes in information related to the production operation of the robot by the operator.

### Solution to Problem

A monitoring device according to the present embodiment includes: first receiving means for receiving, in accordance with a production program for causing a robot to execute a predetermined production operation, an execution history record including a start date and time and an end date and time of the production operation from a robot control device configured to control the robot; second receiving means for receiving a change history record including a date and time when the production program or a variable was manually changed; and determination means for determining whether a time when the production program or the variable was manually changed is during the production operation by comparing the change history record with the execution history record.

### BRIEF DESCRIPTION OF THE DRAWINGS

FIG. 1 shows a robot monitoring system including a monitoring device according to the present embodiment.

FIG. 2 is a functional block diagram of a robot control device shown in FIG. 1.

FIG. 3 is a diagram showing an example of a production program stored in the robot control device shown in FIG. 1.

FIG. 4 shows an example of an execution history management table stored in the robot control device shown in FIG. 1.

FIG. 5 shows an example of a change history management table stored in the robot control device shown in FIG. 1.

FIG. 6 is a functional block diagram of the monitoring device according to the present embodiment.

FIG. 7 shows an example of a change history management table stored in the monitoring device shown in FIG. 6.

FIG. 8 shows an example of a notification screen provided from the monitoring device according to the present embodiment to a user terminal.

FIG. 9 is a flowchart showing an example of the procedure of a monitoring process by the monitoring device according to the present embodiment.

FIG. 10 shows another example of the production program stored in the robot control device shown in FIG. 1.

### DETAILED DESCRIPTION

Hereinafter, a monitoring device according to the present embodiment will be described with reference to the drawings. In the following description, constituent elements having substantially the same function and configuration are denoted by the same reference numeral, and repetitive descriptions will be given only where necessary.

A monitoring device according to the present embodiment is a computer device having a function of determining whether or not a production program for causing a robot to execute a predetermined production operation or information related to the production operation of the robot, such as a variable used in the production program, has been manually changed during the production operation of the robot, and a function of notifying a user terminal set in advance that the information related to the production operation of the robot has been manually changed during the production operation.

In the present embodiment, the “information related to the production operation of the robot” includes information directly related to the operation of the robot, such as information related to the production program and setting information of variables used in the production program. The variables used in the production program include an operation speed, a standby time, a movement format, an interpolation format, and the like. The change in the production program includes changes, additions, and deletions of operation commands and changes, additions, and deletions of teaching positions. The operation commands include a move command, a grasping command, a welding command, a standby command, and the like. The “information related to the production operation of the robot” is not limited to information directly related to the operation of the robot, but includes a wide range of information that affects the entire production operation of the robot. Such information includes system variables in the robot control device, such as variables related to data transmission and reception. In the present embodiment, the “variable” represents not only a numerical value but also a character string or the like which can be handled as a numerical value or a code in the robot control device.

In the present embodiment, “during the production operation of the robot” means that the production program is being executed. When the robot is stationary according to the standby command included in the production program is also included in “during the production operation of the robot”. In addition, in the case where the production operation of the robot is suspended in a midway process and resumed from that process, the period during which the production operation of the robot is suspended is also included in “during the production operation of the robot”. On the other hand, in the case where the robot is caused to repeatedly execute the production operation, the interval between the production operations is typically not included in “during the production operation of the robot”. Of course, the interval between the production operations may be treated as being included in “during the production operation”.

In the present embodiment, an identifier is described in the production program in order to acquire the start date and time and the end date and time of the production operation by the robot. The identifier is for recording the date and time when it is read, and may be the execution command itself or a mark for another program to record the date and time. In the present embodiment, the identifier is referred to as a command.

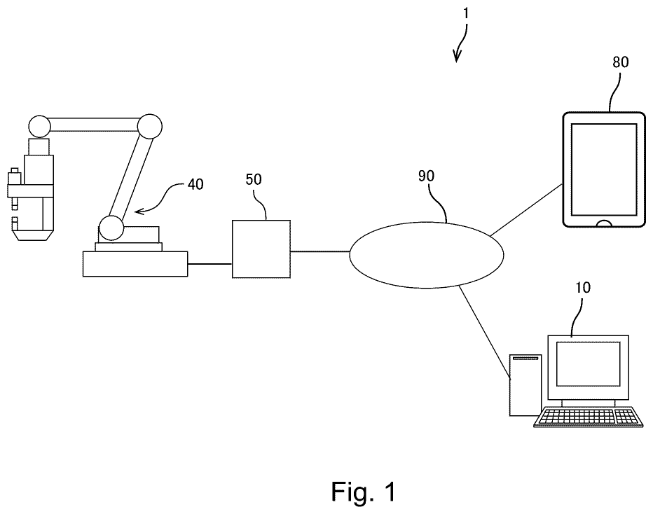

FIG. 1 shows a robot monitoring system 1 including a monitoring device 10 according to the present embodiment. The robot monitoring system 1 includes a robot 40, a robot control device 50 that controls the robot 40, and a monitoring device 10 connected to the robot control device 50 via the Internet 90. A user terminal 80 operated by a user who is responsible for managing the robot 40 is connected to the robot control device 50 and the monitoring device 10 via the Internet 90 or the like.

The user terminal 80 is a computer device having a function of displaying a notification screen provided from the monitoring device 10, a function of displaying a control screen of the robot 40 provided from the robot control device 50, and a function of transmitting various types of information input according to user operations on the user terminal 80 to the robot control device 50. The user terminal 80 is provided by a smartphone, a tablet, a PC, or the like. For example, the various types of information provided from the user terminal 80 to the robot control device 50 include information related to the production operation of the robot 40 and change information thereof, information related to addition of an identifier to the production program, information related to deletion of an identifier described in the production program, and information related to modification of an identifier described in the production program.

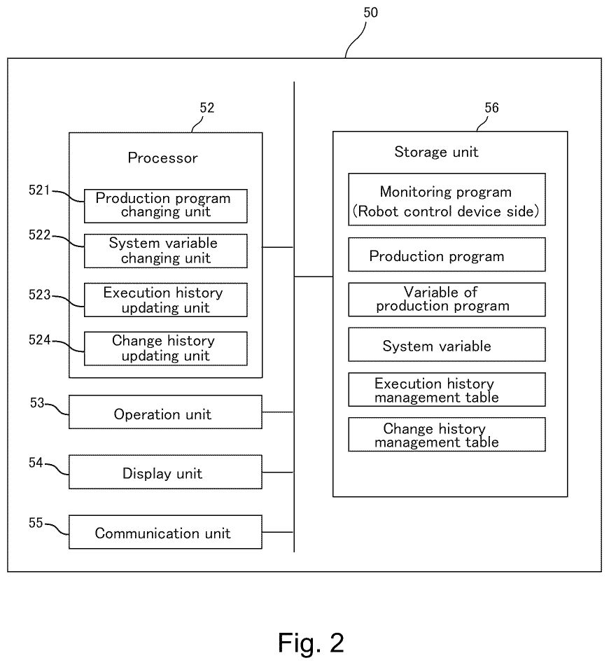

FIG. 2 is a block diagram showing the functions of the robot control device 50. As shown in FIG. 2, the robot control device 50 is configured by connecting hardware such as an operation unit 53, a display unit 54, a communication unit (first and second receiving means) 55, and a storage unit 56 to a processor 52 such as a CPU. The robot control device 50 is provided by a general information processing terminal such as a PC or a tablet.

The operation unit 53 includes an input device such as a keyboard, a mouse, or a jog. The input device may be provided by a touch panel that also serves as the display unit 54, or may be provided by a dedicated operation device (pendant) of the robot control device 50. The user can input information related to the production operation of the robot 40 and change information thereof, information related to addition of an identifier to the production program, information related to deletion of an identifier described in the production program, and information related to modification of an identifier described in the production program to the robot control device 50 through the operation unit 53.

The operation unit 53 has a suspend button for suspending the production operation of the robot 40. The suspend button may be implemented by software. The robot control device 50 controls the robot 40 in accordance with the operation of the suspend button by the user. Specifically, the robot control device 50 suspends the production operation of the robot 40 when the suspend button is pressed, and resumes the suspended production operation of the robot 40 when the suspend button is pressed again.

The display unit 54 has a display device such as an LCD and displays the control screen and the like. The communication unit 55 controls transmission and reception of data between the monitoring device 10 and the user terminal 80. Through the processing of the communication unit 55, the robot control device 50 can receive various types of information from the user terminal 80. The robot control device 50 can also transmit execution history data managed by an execution history management table and change history data managed by a change history management table to the monitoring device 10.

The storage unit 56 includes a storage device such as an HDD or an SSD. The storage unit 56 stores a monitoring program for the robot control device, a production program for causing the robot 40 to execute a production operation, variables used in the production program, and system variables related to internal processing of the robot control device 50. The storage unit 56 also stores the execution history management table and the change history management table.

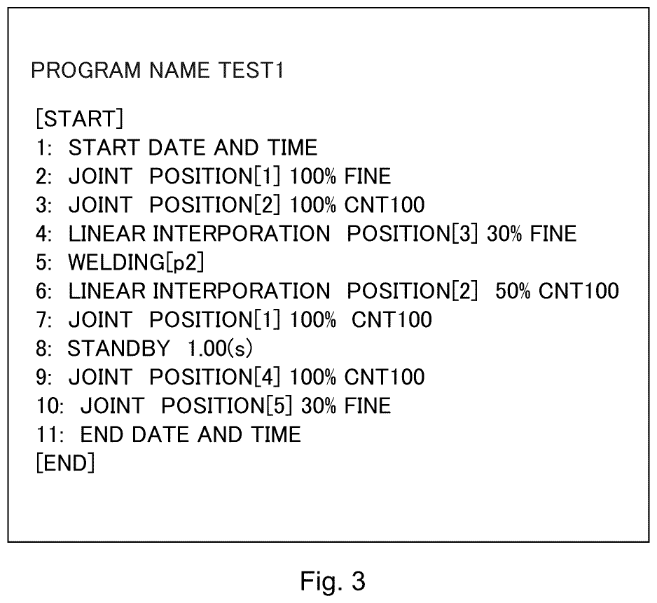

FIG. 3 shows an example of the production program. As shown in FIG. 3, the production program is provided in text format, describes operation commands line by line in accordance with the order of the processes. The operation commands include a move command to move to a teaching position, a grasping command to grasp the workpiece, a release command to release the workpiece, a welding command, a standby command, and the like. For example, the command “POSITION[1]” described in the second line of the production program indicates a move command to move to the teaching position “1”. The command “STANDBY” described in the eighth line indicates a standby command.

In the present embodiment, the production program describes a recording command to record date and time information. Typically, the recording command is described at a position read before the first operation command of the production program and at a position read after the last operation command is read. Specifically, the second line of the production program is the first operation command. Therefore, as a recording command, a command “START DATE AND TIME” for recording date and time information together with a code for identifying a start date and time is described in the first line which is read before the first operation command. Similarly, the tenth line of the production program is the last operation command. Therefore, as a recording command, a command “END DATE AND TIME” for recording date and time information together with a code for identifying an end date and time is described in the eleventh line which is read after the last operation command.

As shown in FIG. 2, when the processor 52 executes the monitoring program for the robot control device stored in the storage unit 56, the robot control device 50 functions as a production program changing unit 521, a system variable changing unit 522, an execution history updating unit 523, and a change history updating unit 524.

The production program changing unit 521 changes the production program and a variable used in the production program in accordance with change information of the information related to the production operation of the robot 40 input through the operation unit 53 and the communication unit 55.

The system variable changing unit 522 changes a system variable in accordance with change information of the system variable input through the operation unit 53 and the communication unit 55.

the execution history updating unit 523 creates a record that collectively includes a product ID, a date and time, a code, a robot name, and a program name in accordance with the reading of the identifier described in the production program, and adds the record to the execution history management table.

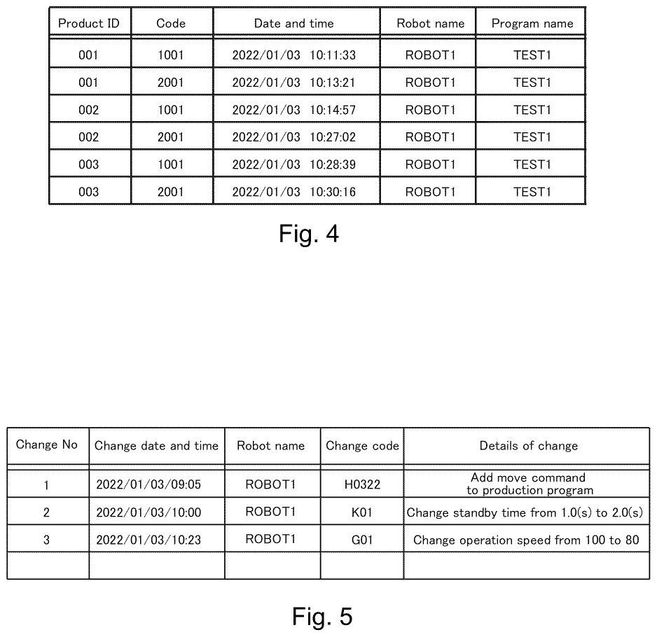

FIG. 4 shows an example of the execution history management table. The execution history management table manages the production start date and time and the production end date and time of the robot 40. As shown in FIG. 4, one record of the execution history management table manages a product ID for individually identifying a product to be produced, a code for individually identifying an identifier described in the production program, a date and time, a robot name for individually identifying the robot 40 used, and a program name for individually identifying the program used.

For example, the product ID is production target information for individually identifying the production target, and corresponds to the number of repetitions in the case where the production operation is repeated. The code “1001” is a code for identifying the start date and time, and the code “2001” is a code for identifying the end date and time. Therefore, the date and time “2022/01/03 10:11:33” corresponding to the product ID “001” and the code “1001” indicates the production start date and time of the first product produced. The date and time “2022/01/03 10:13:21” corresponding to the product ID “001” and the code “2001” indicates the production end date and time of the first product produced. This means that the robot is performing the production operation from the date and time “2022/01/03 10:11:33” to the date and time “2022/01/03 10:13:21”.

In response to the input of change information of the information related to the production operation by the robot 40 via the operation unit 53 or the communication unit 55, the change history updating unit 524 creates a record collectively including a change date and time, a robot name, a change code, and details of the change, and adds the record to the change history management table. The change history management table manages the change date and time when the information related to the production operation by the robot 40 has been changed. Specifically, as shown in FIG. 5, a single record of the change history management table manages a change No., a change date and time, a robot name for individually identifying the robot 40 changed, a change code for individually identifying the item changed, and a specific change.

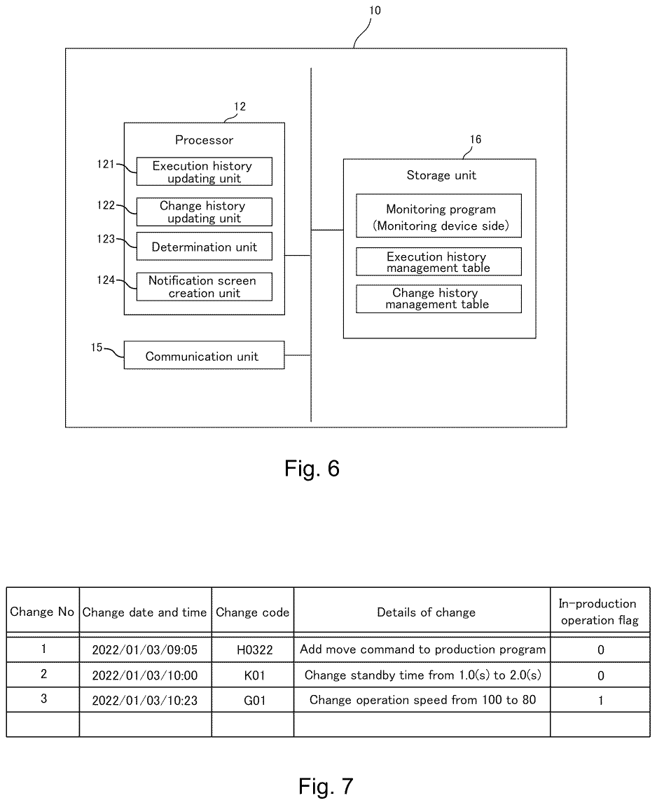

FIG. 6 is a block diagram showing the function of the monitoring device 10. As shown in FIG. 6, the robot control device 50 is configured by connecting hardware such as a communication unit 15 and a storage unit 16 to a processor 12 such as a CPU. The monitoring device 10 is typically provided by a server device.

The communication unit 15 controls transmission and reception of data between the robot control device 50 and the user terminal 80. Through the processing of the communication unit 15, the monitoring device 10 can receive the execution history data and the change history data from the robot control device 50. Further, the monitoring device 10 can transmit the notification screen created by a notification screen creation unit 124 to the user terminal 80.

The storage unit 16 includes a storage device such as an HDD or an SSD. The storage unit 16 stores a monitoring program for the monitoring device. The storage unit 16 also stores the execution history management table (see FIG. 4) and the change history management table (see FIG. 7).

When the processor 12 executes the monitoring program for the monitoring device stored in the storage unit 16, the monitoring device 10 functions as an execution history updating unit 121, a change history updating unit 122, a determination unit (determination means) 123, and a notification screen creation unit 124.

The execution history updating unit 121 adds the execution history data received from the robot control device 50 to the execution history management table. Since the execution history management table is the same as that held by the robot control device 50 shown in FIG. 4, the description thereof will be omitted.

The change history updating unit 122 adds the change history data received from the robot control device 50 to the change history management table, and also adds an in-production operation flag corresponding to a result of determination of the determination unit 123 to be described later to the change history record.

FIG. 7 shows an example of the change history management table stored in the monitoring device 10. As shown in FIG. 7, the change history management table managed by the monitoring device 10 is the change history management table managed by the robot control device 50 with an item “in-production operation flag” added. The in-production operation flag indicates whether or not the corresponding change was made during the production operation. Here, the in-production flag “0” indicates that the change was not made during the production operation, and the in-production flag “1” indicates that the change was made during the production operation.

The determination unit 123 determines whether or not the time at which the information related to the production operation of the robot 40 was changed is during the production operation by comparing the change history record with the execution history.

For example, the change date and time of the change No “1” in the change history management table shown in FIG. 7 is “2022/01/03/09:05”. Referring to the execution history management table held in the monitoring device 10, the changed date and time “2022/01/03/09:05” is a date and time before the start of the production. Therefore, the determination unit determines that the change corresponding to the change No “1” was not made during the production operation. As a result, the in-production operation flag “0” indicating that the change was not made during the production operation is written in the record corresponding to the change No “1”.

The change date and time of the change No “3” in the change history management table shown in FIG. 7 is “2022/01/03/10:23”. Referring to the execution history management table held in the monitoring device 10, the change date and time “2022/01/03/10:23” is a date and time during the production operation of the product ID “002”. Therefore, the determination unit determines that the change corresponding to the change No “3” was made during the production operation. As a result, the in-production operation flag “1” indicating that the change was made during the production operation is written in the record corresponding to the change No “1”.

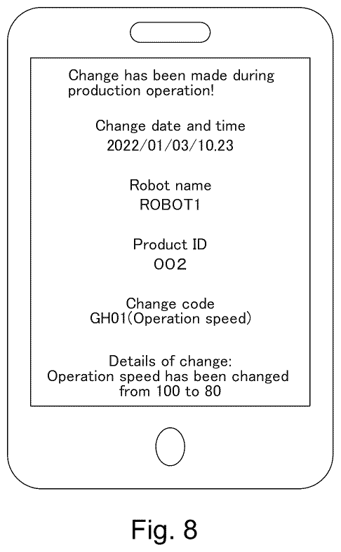

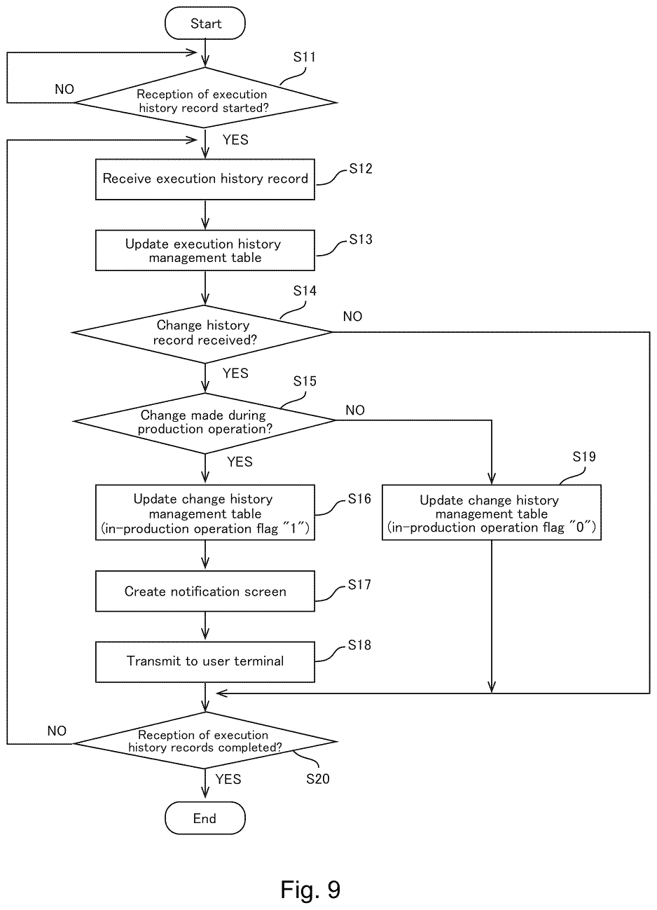

The notification screen creation unit 124 creates a notification screen for notifying the user that the information related to the production operation of the robot 40 has been changed. FIG. 8 shows an example of the notification screen displayed on the user terminal 80. As shown in FIG. 8, the notification screen includes information indicating that the information related to the production operation of the robot 40 has been changed during the production operation, the robot name for which the change was made, the product ID, the change code indicating the changed item, and the specific change. By viewing the notification screen, the user can recognize that the information related to the production operation of the robot 40 has been changed during the production operation, the product that were being produced at the time of change, the changed item, and the specific change.

FIG. 8 is a flowchart showing an example of the procedure of the monitoring process by the monitoring device 10. As shown in FIG. 8, the start of the monitoring process by the monitoring device 10 is waited until the reception of the execution history record is started, in other words, until the control of the robot 40 by the robot control device 50 is started (S11; NO). When the reception of the execution history record is started (S11; YES), the monitoring process by the monitoring device 10 is started. The monitoring device 10 receives the execution history record (S12) and adds the received execution history record to the execution history management table (S13). When receiving the change history (S14; YES), the monitoring device 10 compares the change history record with the history management table, and determines whether or not the change indicated by the change history record was made during the production operation by the robot 40. If it is determined that the change was made during the production operation by the robot 40 (S15; YES), the monitoring device 10 adds the received change history record to the change history management table with the in-production operation flag set to “1” (S16). Then, the monitoring device 10 creates a notification screen (S17), and transmits the created notification screen to the user terminal 80 (S18). If it is determined that the change was not made during the production operation by the robot 40 (S15; NO), the monitoring device 10 adds the received change history record to the change history management table with the in-production operation flag set to “0” (S19).

The processes of steps S12 to S19 are repeatedly executed until the reception of execution history records is completed, in other words, until the control of the robot 40 by the robot control device 50 is completed (S20; NO). When the reception of execution history records is completed (S20; YES), the monitoring process by the monitoring device 10 is completed.

The monitoring device 10 according to the present embodiment achieves the following effects.

The monitoring device 10 according to the present embodiment can determine whether or not the information related to the production operation of the robot 40 has been changed during the production operation of the robot 40 based on the execution history record and the change history record provided from the robot control device 50. Thus, the user can recognize the change in the information related to the production operation of the robot 40, especially during the production operation of the robot 40, which can easily lead to production failure. In addition, the monitoring device 10 can transmit to the user terminal a notification screen for notifying that a change was made during the production operation. The notification screen includes a robot name, a product ID, a changed item, and details of the change, together with text information indicating that a changed was made during the production operation. The risk for production failure to occur varies depending on the changed item and details of the change. For example, the change in the production program and the change in the variables directly related to the production operation of the robot 40 have a higher risk of production failure of the robot 40 than the change in the system variables. Further, the user may manage a plurality of robots 40. By being able to recognize the changed items and the details of the changes through the notification screen, the user can deal with the changes in descending order of the risk of production failure, and can efficiently manage the entire production operation by the plurality of robots 40. In addition, by recognizing the product that were being produced and the robot that was performing the production operation at the time of the change, it is possible to quickly recognize at which robot an abnormality occurred and from which product the abnormality started, and the like, when the abnormality actually occurred in products.

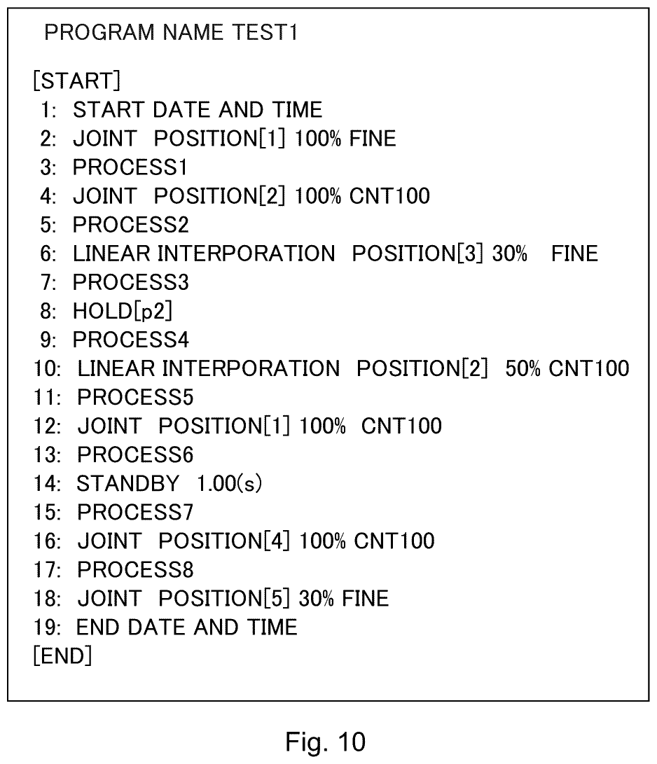

In the present embodiment, in order to acquire the start date and time and the end date and time of the production operation of the robot 40, as shown in FIG. 3, a start command is described at a position read before the first operation command in the production program, and an end command is described at a position read after the last operation command. Thus, whether the robot 40 is during the production operation can be defined by the date and time output by the start command and the date and time output by the end command, and by comparing the change date and time of the information related to the production operation of the robot 40 with those, it can be determined whether or not the change in the information related to the production operation of the robot 40 was made during the production operation. However, it is also possible to acquire the start date and time or the end date and time of at least one of a plurality of processes constituting the production program. For example, in order to acquire the start date and time of each of the plurality of processes constituting the production program, as shown in FIG. 10, a command for acquiring the date and time is described in a line between operation commands in respective lines described in accordance with the order of the processes. Accordingly, not only the start date and time and the end date and time of the production operation but also the start date and time (end date and time) of each process can be acquired, and it can be determined that the information related to the production operation of the robot 40 has been changed during the production operation, and it can be identified in which process the change was made. The user can analyze and recognize the risk of production failure in more detail by recognizing in which process of the production operation the change was made.

The monitoring device 10 according to the present embodiment has a function of creating a notification screen for notifying that information related to the production operation of the robot 40 has been changed during the production operation, and transmitting the notification screen to the user terminal 80. However, regardless of whether or not the change has been made during the production operation, the change in the information related to the production operation of the robot 40 may cause a risk of production failure depending on the details of the production operation by the robot 40. Therefore, the monitoring device 10 may create a notification screen for notifying that the information related to the production operation of the robot 40 has been changed and transmit the notification screen to the user terminal 80, regardless of whether or not the change has been made during the production operation.

In the present embodiment, the monitoring program installed in the robot control device 50 and the monitoring device 10 may be distributed by being recorded on removable media, or may be distributed by being downloaded to users' computers via a network.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. A monitoring device comprising:
a first receiving unit configured to receive, in accordance with a production program for causing a robot to execute a predetermined production operation, an execution history record including a start date and time and an end date and time of the production operation from a robot control device configured to control the robot;
a second receiving unit configured to receive a change history record including a date and time when the production program or a variable was manually changed from the robot control device; and
a determination unit configured to determine whether or not a time at which the production program or the variable was manually changed is during the production operation by comparing the change history record with the execution history record.

2. The monitoring device according to claim 1, further comprising:
a notification unit configured to notify a user that the production program or the variable was manually changed during the production operation of the robot.

3. The monitoring device according to claim 1, wherein
the execution history record includes production target information for individually identifying a production target, and
the monitoring device further comprises:
an identification unit configured to identify a production target when the change was made during the production operation of the robot, based on the production target information.

4. The monitoring device according to claim 1, wherein
the production operation includes a plurality of processes,
the first receiving unit receives from the robot control device an execution history record including a start date and time and an end date and time of each of the processes together with the start date and time and the end date and time of the production operation, and
the determination unit identifies one process in which the production program or the variable was manually changed out of the plurality of processes constituting the production operation by comparing the change history record with the execution history record.

5. A robot monitoring system comprising:
a robot control device configured to control a robot in accordance with a production program for causing the robot to execute a predetermined production operation; and
a monitoring device connected to the robot control device, wherein
the monitoring device includes:
a first receiving unit configured to receive an execution history record including a start date and time and an end date and time of the production operation;
a second receiving unit configured to receive a change history record including a date and time when the production program or a variable was manually changed; and
a determination unit configured to determine whether a time at which the production program or the variable was manually changed is during the production operation by comparing the change history record with the execution history record.
